(19) United States
(12) Patent Application Publication
(10) Pub. No.: US 2009/0009474 A1
(43) Pub. Date: Jan. 8, 2009

(54) IMPROVEMENTS TO INPUT PERIPHERALS FOR A COMPUTER OR THE LIKE

(76) Inventor: Eric Delattre, Villeneuve D'Asq (FR)

Correspondence Address: YOUNG & THOMPSON, 209 Madison Street, Suite 500, ALEXANDRIA, VA, 22314, US

(21) Appl. No.: 12/162,128

(22) PCT Filed: Jan. 25, 2006
(86) PCT No.: PCT/FR06/00170

§ 371 Date: Jul. 25, 2008

(51) Int. Cl. G06F 3/033

(52) U.S. Cl. 345/163

(57) ABSTRACT

An input peripheral for a computer or the like, includes a moving portion (6, 60) handled by the operator and fitted with electrical sensors (40, 41, 44, 47) suitable for generating electrical signals for the computer in response to movements imposed on the moving portion by the operator. The moving portion includes a shell (6) connected to a stationary base (2) via a linkage arranged to allow any movement of the shell (6) relative to the base with the exception of movement in a direction substantially perpendicular to a bearing plane of the base, the moving portion further including a hull (60) that is entrained by the shell (6) and that includes a side wall (63) extending so as to prevent any intrusion under the shell (6) regardless of its position.

The invention relates to improvements made to input peripherals for a computer or the like.

### BACKGROUND OF THE INVENTION

A known computer input peripheral that is commonly referred to as a“mouse” comprises a shell on which the hand of an operator bears and that is fastened on a base that is suitable for sliding on a plane surface. Such a mouse is fitted with electrical sensors suitable for generating electrical signals for the computer in response to movements of the mouse, making it possible to discriminate between movements in two distinct directions, which is sufficient for most office applications, but not sufficient to enable a virtual or real object to be manipulated in three dimensions.

Another known input peripheral, e.g. disclosed in document U.S. Pat. No. 6,333,733, is constituted by a stationary base and by a shell connected to the base via a linkage providing the shell with three degrees of freedom to move in translation and three degrees of freedom to move in rotation relative to the base. The operator moves the shell in three dimensions depending on the movements the operator seeks to impart to the object being manipulated, and the operator can make use of several degrees of freedom simultaneously. The software that makes use of the signals from sensors fitted to such an input peripheral is advantageously programmed so that the movements of the controlled object faithfully reproduce the movements of the shell.

Nevertheless, one of the degrees of freedom corresponds to the shell moving in a direction perpendicular to the bearing plane on which the base of the peripheral rests. This characteristic means that the hand cannot be rested on the shell, which imposes carpal stress (i.e. where the hand joints the wrist) and the wrist is extended, which over time can lead to a musculo-skeletal disorder known as carpal tunnel syndrome.

In addition, carpal stress limits the accuracy with which the shell can be moved.

### OBJECT OF THE INVENTION

An object of the invention is to provide an input peripheral that attenuates the above-mentioned drawback.

### BRIEF DESCRIPTION OF THE INVENTION

In order to achieve this object, there is provided an input peripheral for a computer or the like, the peripheral comprising a moving portion handled by the operator and fitted with electrical sensors suitable for generating electrical signals for the computer in response to movements imposed on the moving portion by the operator. According to the invention, said moving portion comprise a shell connected to a stationary base by means of a linkage arranged to allow any movement of the shell relative to the base with the exception of movement in a direction substantially perpendicular to a bearing plane of the base, the moving portion further comprising a hull that is entrained by the shell and that includes a side wall extending so as to prevent any intrusion under the shell regardless of its position.

The shell can then be manipulated with five degrees of freedom corresponding to two degrees of freedom to move in translation in directions that are substantially parallel to the bearing plane of the base, and three degrees of freedom to move in rotation, that can be made to correspond with the corresponding five degrees of freedom of the object being manipulated.

The missing sixth degree of freedom can be controlled by a control member fitted to the peripheral.

Thus, it is possible to control at least five degrees of freedom of the manipulated object while the hand continues to be rested, and while maintaining very instinctive correspondence between the movements of the shell and the movements of the objects being manipulated.

In addition, resting the hand on the shell serves to increase the accuracy with which it is moved.

The hull serves to ensure that the operator does not get a finger pinched by inadvertently or clumsily inserting the finger under the edge of the shell. In addition, the hull protects the internal mechanism of the peripheral from dust and other pollution.

### BRIEF DESCRIPTION OF THE DRAWINGS

The invention can be better understood in the light of the following description given with reference to the figures of the accompanying drawings, in which:

FIG. 1 is a longitudinal section view of an input peripheral in a particular embodiment of the invention;

FIG. 2 is a section view on line II-II of FIG. 1;

FIG. 3 is a fragmentary perspective view of the input peripheral shown in FIGS. 1 and 2, the shell and the hull being removed;

FIG. 4 is a perspective view of the hull that forms part of the peripheral of the invention;

FIG. 5 is a perspective view of the peripheral of the invention;

FIG. 6 is a diagram showing the movements that are possible for the shell of the input peripheral of the invention; and

FIG. 7 is a view analogous to FIG. 2 showing some of the movement control means forming part of the peripheral of the invention.

### DETAILED DESCRIPTION OF THE INVENTION

With reference to FIG. 1, the input peripheral 1 of the invention comprises a base 2 having a leg 3 with its end engaged in a soleplate 4 that is resting on a bearing plane P defined in this example by a table top 5.

The input peripheral 1 comprises a shell 6 of ergonomic domed shape suitable for being held easily in the hand.

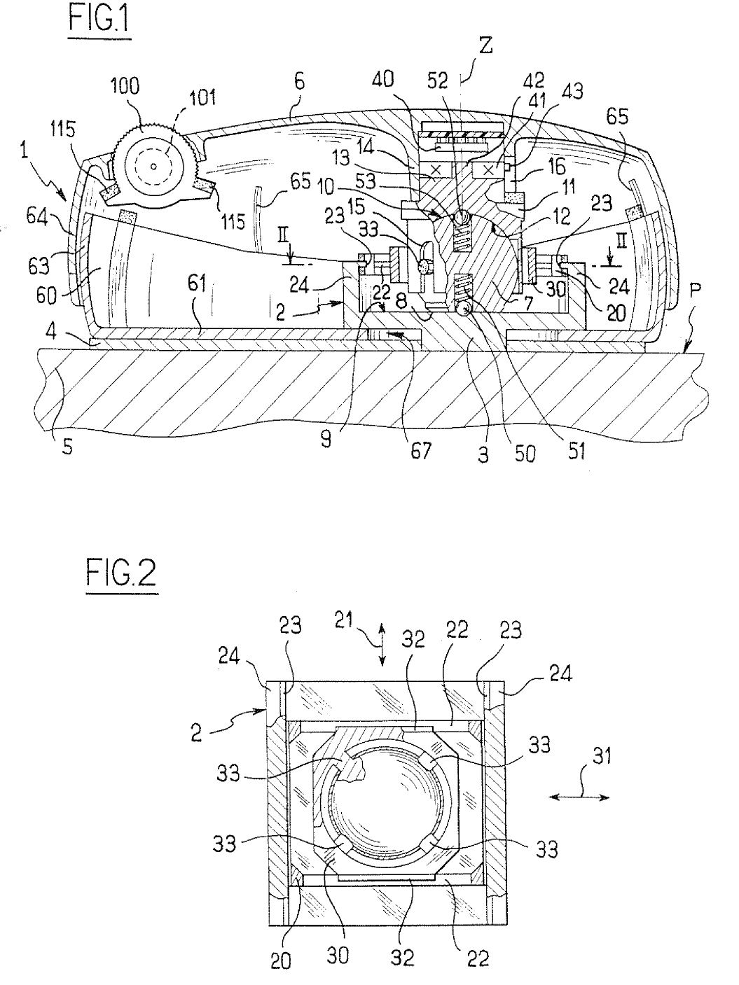

The shell 6 is connected to the base 2 by means of a linkage made up as follows:
a first connection element 7 having a plane bottom end 8 that extends against a plane surface 9 of the base 2 parallel to the bearing plane P, and a spherical top end 10. The first connection element 7 is thus free to slide on the plane surface 9; and
a second connection element 11 having a bottom end 12 in the form of a spherical cavity complementary to the spherical top end 10 of the first connection element 7 and fitted thereon so as to form a ball-and-socket connection between these two elements, and having a circularly cylindrical top end 13 that rotatably receives a complementary circularly cylindrical cavity 14 of the shell 6 so as to form between the second connection element 11 and the shell 6 a pivot connection about a pivot axis referenced 7 that passes through the center of the spherical end 10. The second connection element 11 is prevented from turning about the pivot axis Z by stop means described in greater detail below with reference to FIG. 2.

These dispositions make the following movements possible:
the shell 6 can tilt angularly relative to the base 2 under the effect of a torque imposed by the hand of an operator on the shell 6 about axes that are contained in an equatorial plane of the spherical end 10 and parallel to the bearing plane P;
the shell 6 can turn relative to the base 2 about the pivot axis Z; and
the shell 6 can move in translation relative to the base 2 under the effect of a force developed in the base plane by the hand of the operator, during which the plane bottom end 6 of the first connection element 7 slides on the plane surface 9 of the base 2.

The tilting and the turning give the shell 6 three degrees of freedom in rotation, whereas the movement in translation gives the shell 6 two degrees of freedom in translation.

It should be observed that a force exerted by the hand of the operator on the shell 6 in a transverse direction perpendicular to the plane surface 9 is transmitted directly to the base 2 via the connection elements 7 and 11, and gives rise to no movement of the shell 6. The operator can thus rest the hand on the shell 6, thereby relieving the arm and avoiding any carpal stress.

The five degrees of freedom of the shell 6 made possible by the linkage between the shell 6 and the base 2 are advantageously used to represent the five corresponding degrees of freedom of a virtual or real object being manipulated with the help of the input peripheral of the invention.

The sixth degree of freedom, i.e. the degree that corresponds to moving in translation in the transverse direction that is prevented by the linkage, is controlled in this example by means of a scroll wheel 100 carried by the shell 6.

As can be seen in FIG. 2, the input peripheral 1 is fitted with auxiliary parts, namely a first slider 20 and a second slider 30. The first slider 20 is mounted on the base 2 to slide in a direction 21 that extends in the above-mentioned equatorial plane. For this purpose, and as can be seen in FIG. 1, the first slider 20 has side walls with slots formed therein that receive tenons 23 carried by uprights 24 secured to the base 2 and facing each other on opposite sides of the plane surface 9.

The second slider 30 is mounted in the first slider 20 to slide in a direction 31 that extends in the above-mentioned equatorial plane, perpendicularly to the direction 21. For this purpose, the second slider has tenons 32 that are received in grooves 22 in the first slider 20.

It should be observed that the first slider 20 and the second slider 30 are never subjected directly to the force delivered by the hand of the operator. In particular, they are never subjected to any transverse force transmitted directly from the shell 6 to the base 2 via the connection elements 7 and 11. The sliders 20 and 30 are subjected solely to driving forces in a plane that is parallel to the plane surface 9. They are therefore subjected to very little stress.

The sliders 20 and 30 do not contribute to defining the linkage between the shell 6 and the base 2 except insofar as they prevent the second connection element 11 from turning about the pivot axis Z.

For this purpose, the first connection element 7 and the second slider 30 are connected together by studs 33 that extend in radial directions contained in the above-mentioned equatorial plane. In practice, the first connection element 7 and the second slider 30 are molded as a single piece. As a result, the second slider 30 is permanently centered on the spherical end 10 of the first connection element 7 and tracks the movements thereof.

To enable the shell 6 to tilt angularly in spite of the presence of the studs 33, the spherical cavity 12 in the second connection element 11 includes grooves 15 (one of which is visible in FIG. 1) allowing the studs 33 to pass through the wall of the spherical cavity 12, and enabling the second connection element 11 to tilt angularly about an axis contained in the above-mentioned equatorial plane, while preventing the second connection element 11 from turning about the pivot axis Z.

Thus, during a movement of the shell 6, the second slider 30 moves by an amount equal to the component of the movement of the shell 6 in said direction 31, and it entrains the first slider 20, causing it to move by an amount equal to the component of the movement of the shell 6 in the direction 21.

During turning of the shell 6, the shell 6 turns relative to the second connection element 11 by an amount that is equal to the component of the turning about the pivot axis Z of the shell 6 relative to the second connection element 11.

These arrangements make it easy to put sensors into place for sensing the various movements of the shell 6.

In this respect, and as can be seen in FIG. 1, the shell 6 carries a two-axis inclinometer 40 suitable for measuring tilting movements of the shell 6 in rotation about axes contained in the equatorial plane.

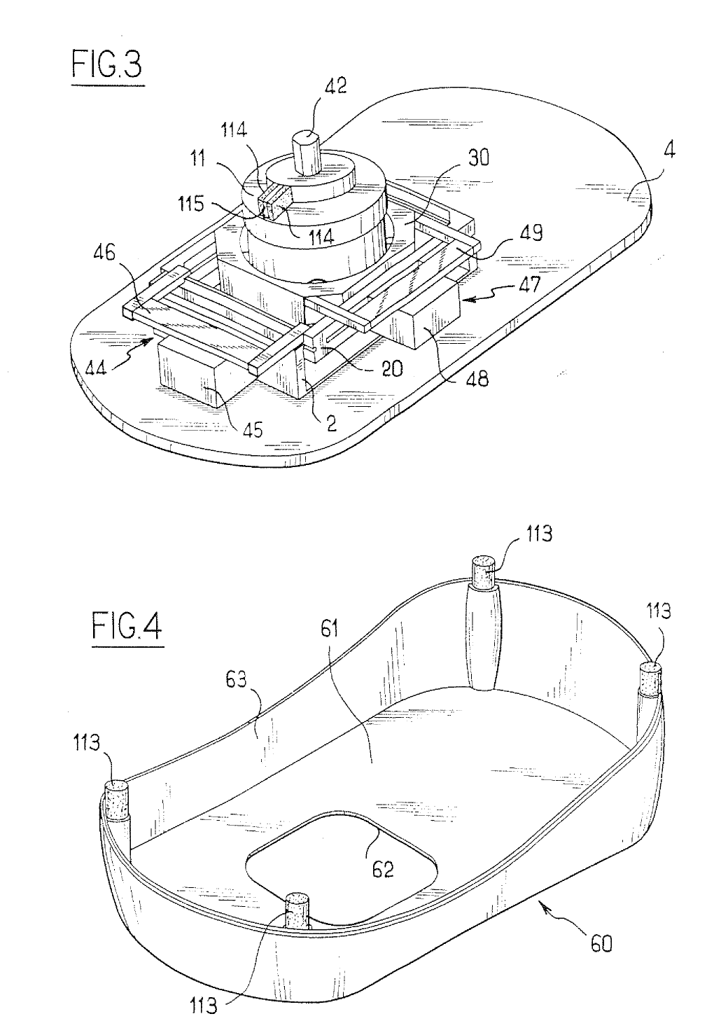

In addition, the input peripheral of the invention includes a potentiometer 41 disposed between the second connection element 11 and the shell 6 to measure turning about the pivot axis Z. The potentiometer 41 comprises an inner portion and an outer portion that are free to turn relative to each other about the pivot axis Z. The inner portion is engaged on a peg 42 of the second connection element 11 that presents a flat (visible in FIG. 3) for preventing the inner portion from turning. The outer portion is prevented from turning relative to the shell 6 by means of a snug 43 co-operating with the flanks of an opening 16 in the circularly cylindrical cavity 14 of the shell 6.

These two sensors serve to measure all movements in rotation of the shell about the center of the spherical end 10 of the first connection element 7.

Furthermore, and as can be seen in FIG. 3, the input peripheral of the invention has a first rectilinear movement sensor 44 comprising an optical reader 45 secured to the base 2 and an optical ruler 46 secured to the first slider 20, and a second rectilinear movement sensor 47 comprising an optical reader 48 secured to the first slider 20 and an optical ruler 49 secured to the second slider 30. These two rectilinear movement sensors enable the rectilinear movements of the shell 6 along the directions 21 and 31 to be measured.

Finally, for the sixth degree of freedom controlled by the scroll wheel 100, a rotation sensor 101 (represented by dashed lines since it is hidden by the wheel 100) is placed on the axis of the wheel 100 to measure movement in rotation thereof.

According to a particular aspects of the invention, the input peripheral includes means for reinitializing the sensors, which means are visible in FIG. 1.

The reinitialization means comprise firstly a first ball 50 placed in a housing hollowed out in the first connection element 7 and opening out to the plane bottom end 8 thereof, the ball being urged against the plane surface 9 of the base 2 by a spring 51. In the position shown in FIG. 1, the first ball 50 is engaged in a hollow formed on the plane surface 9 of the base 2 in the center of said surface, thereby enabling the shell 6 to be indexed relative to the base 2. For example, by placing a switch in the bottom of the hollow so as to be driven by the first ball 50, it is possible to obtain an electrical signal that can be used to reinitialize the electrical signal coming from the rectilinear movement sensors 44 and 47 when the shell 6 is thus indexed relative to the base 2.

The reinitialization means also comprise a second ball 52 received in a housing hollowed out in the first connection element 7 so as to open out into the top of the top spherical end 10 thereof, and urged against the spherical cavity 12 of the second connection element 11 by a spring 53. In the position shown in FIG. 1, the second ball 52 is engaged in a hollow made in the spherical cavity 12 in line with the pivot axis Z, thereby enabling the second connection element 11 to be indexed relative to the first connection element 7, and on the same principle as described above, enabling the electrical signals coming from the inclinometer 40 to be reinitialized.

In the invention, the input peripheral also includes a hull 60 that can be seen more particularly in FIG. 4, which hull comprises a bottom 61 with an orifice 62, and a side wall 63 that bulges outwards a little.

As can be seen in FIG. 1, the hull 60 is placed under the shell 6 so that the bottom 61 of the hull 60 bears against the soleplate 4, while the side wall 63 co-operates externally with a complementary side wall 64 of the shell 6.

The orifice 62 allows the leg 3 of the base 2 to pass through the bottom 61. The orifice is large enough to enable the shell 6 to move, while being small enough to ensure that the bottom 61 always remains captive in the space 67 that extends between the soleplate 4 and the base 2. The hull 60 is thus constrained to move parallel to the soleplate 4, and thus to the bearing plane P.

The co-operation between the side walls of the hull 60 and the shell 6 constrains the hull 60 to follow the linear movements of the shell 6 and to follow its movements in rotation about an axis parallel to the transverse direction, with the shape of the walls 63 and 64 nevertheless allowing the shell 6 to tilt angularly relative to the hull 60.

The hull 60 prevents any objects or pollution from penetrating under the shell 6. Furthermore, it prevents a clumsy operator getting fingers pinched between the shell 6 and the soleplate 4.

In practice, the side walls of the hull 60 and of the shell 6 face each other with a small amount of clearance. Skids 65 integrally molded on the inside face of the side wall 64 of the shell 6 provide contact over a small area with the side wall 63 of the hull 60 so as to reduce friction between these two elements.

The input peripheral of the invention is particularly suitable for being used together with computer-assisted design (CAD) software, or with software for viewing virtual objects.

As can be seen in FIG. 5, a wire 66 conveying the electrical signals from the various sensors leaves the hull 60 to be connected to a computer 70, where the software is installed.

The input peripheral can be used in several ways. Firstly, each position of the shell 6 and of the scroll wheel 100 as measured by the sensors can be associated with a position in the virtual space in which the virtual object being manipulated is to be found. It is also possible to associate each position of the shell 6 and of the scroll wheel 100 with a travel speed in the virtual space in which the virtual object being manipulated is to be found.

In a particular aspect, both types of association can be combined, using the following method.

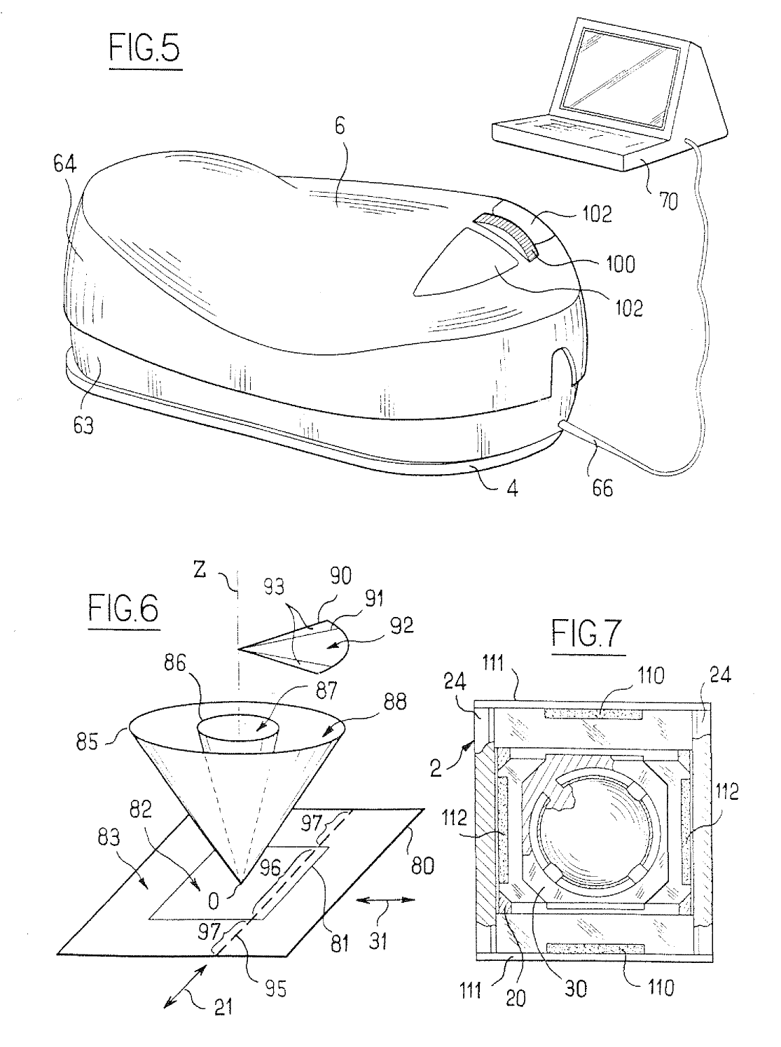

In FIG. 6, there can be seen a diagram representing the five degrees of freedom of the shell 6.

The rectangle 80 defines the set of positions that can be occupied in the above-mentioned equatorial plane by the center of the spherical end 10 of the first connection element 7. An inner rectangle 81 within the rectangle 80 defines a central zone 82 and a peripheral zone 83.

The following associations are then selected: each position of the shell 6 in the central zone 82 is associated with a position of the virtual object in the virtual space; and each position of the shell 6 in the peripheral zone 83 is associated with a travel speed of the virtual object in the virtual space.

Similarly, the cone 85 defines the angular tilting possible for the pivot axis Z about said center. An inner cone 86 within the outer cone 85 defines a central zone 87 and a peripheral zone 88.

The following associations are then selected: each position of the pivot axis Z in the central zone 86 is associated with an angular position of the virtual object in the virtual space; and each position of the shell 6 in the peripheral zone 88 is associated with a speed of rotation of the virtual object in the virtual space.

Finally, the angular sector 90 defines possible turning of the shell 6 about the pivot axis Z. An inner angular sector 91 within the angular sector 90 defines a central zone 92 and a peripheral zone 93.

The following associations are then selected: each angular position of the shell 6 in the central zone 92 is associated with an angular position of the virtual object in the virtual space; and each angular position of the shell 6 in the peripheral zone 93 is associated with a speed of rotation of the virtual object in the virtual space.

The same principles are applied to the scroll wheel 100.

In order to show up these various zones, the input peripheral of the invention is fitted with means for controlling the movement of the shell 6.

As can be seen in FIG. 7, the control means comprise foam pads 110 placed on supports 111 and extending between the ends of the uprights 24 of the base 2 so as to form resilient abutments against which the first slider 20 comes into abutment at the ends of its stroke.

The portion of the movement of the first slider 20 in which the first slider 20 does not come into contact with either of the foam pads 110 corresponds to the central zone 82. In this portion, the shell 6 is not subjected to any opposing force (except for low levels of friction). The portion of the movement of the first slider 20 in which the first slider 20 is in contact with one or the other of the foam pads 110 corresponds to the peripheral zone 83. In this portion, the shell 6 is subjected to a return force because of the first slider bearing against one or the other of the foam pads 110. The presence of a return force enables the operator to distinguish between the central zone and the peripheral zone.

By way of example, there follows a description of a rectilinear movement of the shell 6 in the direction 21, i.e. the direction in which the first slider 20 moves. This movement is represented in FIG. 6 by dashed line 95. This line includes a central range 96 that is said to be “isotonic”, that extends in the central zone 62 and that corresponds to free movement of the shell 6. The line 95 has two end ranges 97 that are said to be “elastic”, each of which extends in the peripheral zone 83 and corresponds to movement of the shell 6 that is subjected to a return force towards the central range.

In similar manner, the control means include foam pads 112 disposed on the first slider 20 so as to form resilient abutments against which the second slider 30 comes into abutment at the ends of its stroke. The foam pads 112 mark the boundary between the central zone 82 and the peripheral zone 84 for rectilinear movements along the direction 31.

The control means also comprise foam pads 113 (visible in FIG. 4) disposed on the hull 60 to form resilient abutments against which the shell 6 comes into abutment at the ends of its angular tilting stroke about axes contained in the equatorial plane. The foam pads 113 mark the boundary between the central zone 87 and the peripheral zone 88 for angular tilting of the shell 6 about axes contained in the equatorial plane.

Finally, the control means include foam pads 114 (visible in FIG. 3 and in FIG. 1) disposed on either side of a partition 115 of the second connection element 11 so as to form resilient abutments against which the flanks of the opening 16 in the circularly cylindrical cavity 14 of the shell 6 come into abutment at the ends of its stroke. The foam pads 114 mark the boundary between the central zone 92 and the peripheral zone 93 for the shell 6 turning about the pivot axis Z.

It is thus possible for all of the degrees of freedom of the shell 6 to define a central range in which the movement of the shell is free, and end ranges in which the shell is subjected to a return force towards the central range.

Similarly, the scroll wheel 100 carries foam pads 115 (visible in FIG. 1) that perform the same function.

Thus, so long as the shell is in the central zones, the software makes the position of the shell correspond to the position of the virtual object in the virtual space. The operator then has the impression of moving the virtual object displayed on the screen directly when moving the shell 6, in a manner that is very instinctive. If the operator pushes the shell 6 so that it enters into one of the peripheral zones, then the software associates the position of the shell 6 with movement at a given speed, e.g. in order to go quickly to some other portion of the virtual object in order to view said other portion.

The invention is not limited to the description above, but on the contrary covers any variant coming within the ambit defined by the claims.

In particular, although a particular linkage is shown that enables the shell to move in any manner relative to the base with the exception of moving in a transverse direction that is perpendicular to the bearing plane, the invention covers any other linkage providing this type of connection, such as for example a single connection element having a plane bottom end that slides on a plane surface of the baser and a spherical top end that is received in a complementary spherical cavity of the shell.

Although the hull is shown as having a side wall that extends inside the side wall of the shell, the side wall of the hull could extend over the outside of the side wall of the shell.

Although it is stated that speeds or positions are associated with the position of the shell and the position of the scroll wheel, it is possible to associate other parameters for manipulating the object therewith, such as zooms, or indeed color changes.

Although it is stated that each degree of freedom has an isotonic central range and elastic end ranges, it is possible to provide for each degree of freedom any possible configuration going from a degree of freedom that is completely isotonic, to a degree of freedom that is completely elastic.

Although in the example shown, the positions of the shell and of the scroll wheel in the central ranges are associated with positions of the virtual object, and the positions of the shell and of the scroll wheel in the end ranges are associated with travel speeds of the virtual object, other associations could be provided, such as a slow speed in the central range and a fast speed in the end ranges.

Furthermore, although the movement control means of the shell are constituted by foam pads that co-operate with moving portions of the peripheral, other control means could be used, such as servo-controlled motors leaving movement free in a central range while opposing a return force on such movements in end ranges. Alternatively, the peripheral need have no control means, or could have control means that act on only some of the degrees of freedom of the shell. It should be observed that the central and peripheral ranges managed by the software associated with the peripheral need not coincide with the central and peripheral ranges marked by the control means.

Although the shell is shown as including a member in the form of a scroll wheel for controlling an additional degree of freedom, the peripheral could include other types of control member, such as a pointer placed on the shell or some other location of the peripheral.

In addition, the peripheral may include other types of member, such as selection buttons 102 (visible in FIG. 5) placed on the shell, similar to those that are to be found on a mouse.

Finally, although the input peripheral is described herein in association with computer design and display software, the input peripheral could be used as a member for manipulating a real object, for example via a manipulator arm.

1. An input peripheral for a computer or the like, the peripheral comprising a moving portion (6, 60) handled by the operator and fitted with electrical sensors (40, 41, 44, 47) suitable for generating electrical signals for the computer in response to movements imposed on the moving portion by the operator, the peripheral being characterized in that said moving portion comprise a shell (6) connected to a stationary base (2) by means of a linkage arranged to allow any movement of the shell (6) relative to the base with the exception of movement in a direction substantially perpendicular to a bearing plane of the base, the moving portion further comprising a hull (60) that is entrained by the shell (6) and that includes a side wall (63) extending so as to prevent any intrusion under the shell (6) regardless of its position.

2. An input peripheral according to claim 1, further including means (62, 67) for limiting the movements of the hull (60) to movements parallel to the bearing plane, the shell (6) having a side wall (64) that extends facing a side wall (64) of the hull (60), the side walls (63, 64) co-operating with each other so as to ensure that the hull (60) is entrained by the shell (6) while enabling the shell (6) to tilt angularly about axes parallel to the bearing plane.

3. An input peripheral according to claim 2, characterized in that the means for limiting movements of the hull comprise a space (67) extending between the base (2) and a soleplate (4) of the base (2) in which a bottom (61) of the hull (60) is inserted.

4. An input peripheral according to claim 1, in which the linkage comprises:
a first connection element (7) connected to the base via a connection leaving two movements free along directions parallel to the bearing plane; and
a second connection element (11) connected firstly to the first connection element (7) via a ball-and-socket connection, and connected secondly to the shell (6) via a pivot connection having a pivot axis (Z) that coincides with the center of the ball-and-socket connection;
the input peripheral including stop means (15, 33) for preventing the second connection element from moving in rotation about the pivot axis (Z).

5. An input peripheral according to claim 4, characterized in that it includes a first slider (20) mounted to slide on the base (2) in a plane parallel to the bearing plane in a first direction (21), and a second slider (30) mounted to slide on the first slider (20) in said plane in a second direction (31) perpendicular to the first direction, the second slider including centering means (33) for centering it on the first connection element (11).

6. An input peripheral according to claim 5, characterized in that the centering means comprise at least one stud (33) extending between the second slider (30) and the first connection element (7) to secure it to the second slider (30), the second connection element including a groove (15) engaged on the stud (33) and co-operating therewith to form the stop means for preventing movement in rotation of the second connection element (11) about the pivot axis (Z).

7. An input peripheral according to claim 1, further including reinitialization means (50, 52) for reinitializing at least one of the sensors when the shell (6) is in a predetermined position.

8. An input peripheral according to claim 1, further including control means (110, 112, 113, 114) for controlling the movement of the shell (6) relative to the base (2) in at least one of the degrees of freedom in movement of the shell (6), such that said degree of freedom presents a central range (96) in which the control means are adapted to leave the shell (6) free to move in any position, and end ranges (97) in which the control means are adapted to leave the shell (6) free to move to any position against a return force towards the central range.

9. An input peripheral according to claim 8, in which the movement control means of the shell (6) comprise at least one resilient pad (110, 112, 113, 114) adapted to form an abutment for an element (20, 30, 6) of the input peripheral that moves with the shell (6).

10. An input peripheral according to claim 1, including a control member (100) for controlling an additional degree of freedom.

11. An object manipulation device comprising an input peripheral according to claim 8 and means for manipulating the object as a function of the position of the shell of the input peripheral, which means are adapted:
to associate a position of the shell (6) with a first object-manipulation parameter when said position lies in the central range; and
to associate a position of the shell (6) with a second object-manipulation parameter when said position lies in either end ranges.
